(19) United States
(12) Patent Application Publication
(10) Pub. No.: US 2013/0232194 A1
(43) Pub. Date: Sep. 5, 2013

(54) EVENT APPLICATION

(71) Applicant: MYSPACE LLC, Beverly Hills, CA (US)

(72) Inventors: Jason J.A. Knapp, Solana Beach, CA (US); Michael Scott Andler, Los Angeles, CA (US); Thomas B. Werz, III, Los Angeles, CA (US); James Andrew Beaupre, Los Angeles, CA (US); Ali Tahmasbi, Manhattan Beach, CA (US)

(73) Assignee: MYSPACE LLC, Beverly Hills, CA (US)

(21) Appl. No.: 13/786,178

(22) Filed: Mar. 5, 2013

Related U.S. Application Data
(60) Provisional application No. 61/606,858, filed on Mar. 5, 2012.

(51) Int. Cl. H04L 29/08

(52) U.S. Cl. CPC H04L 67/10
USPC 709/203

(57) ABSTRACT

A system, method, and article of manufacture provide the ability to manage event-based information/content. A client application uploads information about an event to an event application executing on a server. The event application manages information for an event site that corresponds to an event that multiple persons attend and is an electronic representation of the event. The event application receives the uploaded information and manages client access to the uploaded information.

### CROSS-REFERENCE TO RELATED APPLICATIONS

This application claims the benefit under 35 U.S.C. Section 119(e) of the following co-pending and commonly-assigned U.S. provisional patent application(s), which is/are incorporated by reference herein:

U.S. Patent Application Ser. No. 61/606,858, entitled “EVENT APPLICATION”, by Jason J. A. Knapp, et. al., filed on Mar. 5, 2012, Attorney Docket No. 257.6-US-P1.

This application is related to the following co-pending and commonly-assigned patent application, which application is incorporated by reference herein:

U.S. patent application Ser. No. ______, entitled “MAP BASED EVENT NAVIGATION AND VENUE RECOMMENDATION SYSTEM”, by Jason J. A. Knapp, et. al., filed on the same date herewith, Attorney Docket No. 257.7-US-U1, which application claims priority to U.S. Patent Application Ser. No. 61/606,878, entitled “MAP BASED EVENT NAVIGATION AND VENUE RECOMMENDATION SYSTEM”, by Jason J. A. Knapp, filed on Mar. 5, 2012, Attorney Docket No. 257.7-US-P1.

### BACKGROUND OF THE INVENTION

1. Field of the Invention

The present invention relates generally to social media content, and in particular, to a method, apparatus, and article of manufacture for providing an interactive website presence for an event such as a concert, sporting event, charity event, etc.

2. Description of the Related Art

In prior art social media applications, users are able to post pictures, information, etc., about themselves or an activity that the user has participated in/attended, on a user's personal webpage. Any user's postings are considered “status updates” by the user and may also be reflected on personal webpages of the user's “friends.” While a user can make his/her postings public so that any user can view the postings, there is no mechanism available with which to discover all postings by one or more users related to a particular event such as a concert, sporting event, charity event, party, etc. In this regards, there is currently no interactive web presence for an event itself where users (whether friends or not) can discuss, post related pictures, post information, etc. about the event and share their experiences. The lack of availability of such an event site may be due to a variety of factors including a lack of recognition of the interest in such a site, the failure to recognize the lack of existence of such a site, the lack of motivation for users to contribute to such a site, etc. Accordingly, what is needed is an interactive website presence for an event/category of events that allows users to share common experiences, preferences, and thoughts while also motivating users to participate interactively.

### SUMMARY OF THE INVENTION

Embodiments of the invention provide an interactive web presence for an event that provides the ability for users to “check into” an event and upload content directly from the actual event using a mobile application. The server hosting the interactive website may then be used to verify the user's location (and also confirm the content location) and tags the uploaded data appropriately. The interactive web presence may serve as an aggregate for user content uploaded from the event. Thereafter, any user can visit the interactive website and view the content. Events represented by the interactive website are not limited to concerts or particular events/types of events and may include sporting events, parties, charity events, or any event/type of event that may benefit from an aggregation of users (e.g., television show viewing events, etc.).

### BRIEF DESCRIPTION OF THE DRAWINGS

Referring now to the drawings in which like reference numbers represent corresponding parts throughout:

FIG. 1 is an exemplary hardware and software environment used to implement one or more embodiments of the invention;

FIG. 2 schematically illustrates a typical distributed computer system using a network to connect client computers to server computers in accordance with one or more embodiments of the invention;

FIG. 3 illustrates the general structure and interaction within an event based framework/system in accordance with one or more embodiments of the invention; and

FIG. 4 illustrates the logical flow for providing an event application 306 in accordance with one or more embodiments of the invention.

### DETAILED DESCRIPTION OF THE PREFERRED EMBODIMENTS

In the following description, reference is made to the accompanying drawings which form a part hereof, and which is shown, by way of illustration, several embodiments of the present invention. It is understood that other embodiments may be utilized and structural changes may be made without departing from the scope of the present invention.

### Hardware Environment

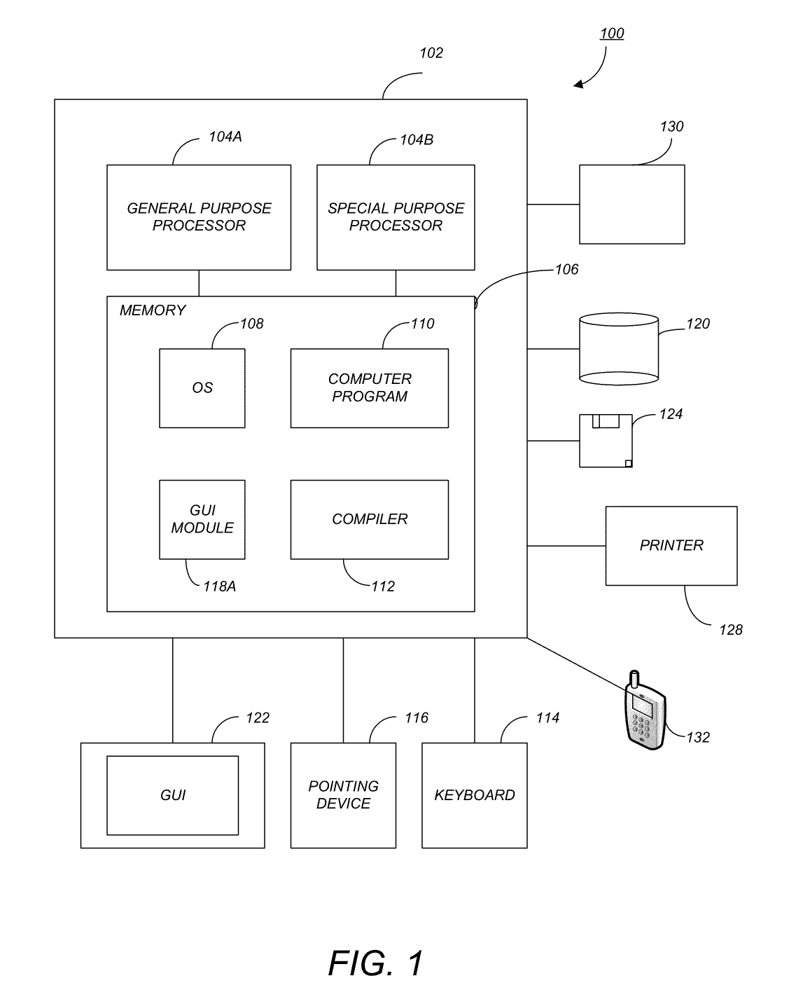

FIG. 1 is an exemplary hardware and software environment 100 used to implement one or more embodiments of the invention. The hardware and software environment includes a computer 102 and may include peripherals. Computer 102 may be a user/client computer, server computer, or may be a database computer. The computer 102 comprises a general purpose hardware processor 104A and/or a special purpose hardware processor 104B (hereinafter alternatively collectively referred to as processor 104) and a memory 106, such as random access memory (RAM). The computer 102 may comprise or may be coupled to and/or integrated with other devices, including input/output (I/O) devices such as a keyboard 114, a cursor control device 116 (e.g., a mouse, a pointing device, pen and tablet, touch screen, multi-touch device, etc.) and a printer 128. In one or more embodiments, computer 102 may be coupled to or may comprise a portable or media viewing/listening device 132 (e.g., an MP3 player, iPod™, Nook™, portable digital video player, cellular device, personal digital assistant, etc.). In yet another embodiment, the computer 102 may comprise a multi-touch device, mobile phone, gaming system, internet enabled television, television set top box, or other internet enabled device executing on various platforms and operating systems.

In one embodiment, the computer 102 operates by the general purpose processor 104A performing instructions defined by the computer program 110 under control of an operating system 108. The computer program 110 and/or the operating system 108 may be stored in the memory 106 and may interface with the user and/or other devices to accept input and commands and, based on such input and commands and the instructions defined by the computer program 110 and operating system 108 to provide output and results.

Output/results may be presented on the display 122 or provided to another device for presentation or further processing or action. In one embodiment, the display 122 comprises a liquid crystal display (LCD) having a plurality of separately addressable liquid crystals. Alternatively, the display 122 may comprise a light emitting diode (LED) display having clusters of red, green and blue diodes driven together to form full-color pixels. Each liquid crystal or pixel of the display 122 changes to an opaque or translucent state to form a part of the image on the display in response to the data or information generated by the processor 104 from the application of the instructions of the computer program 110 and/or operating system 108 to the input and commands. The image may be provided through a graphical user interface (GUI) module 118A. Although the GUI module 118A is depicted as a separate module, the instructions performing the GUI functions can be resident or distributed in the operating system 108, the computer program 110, or implemented with special purpose memory and processors.

In one or more embodiments, the display 122 is integrated with/into the computer 102 and comprises a multi-touch device having a touch sensing surface (e.g., track pod or touch screen) with the ability to recognize the presence of two or more points of contact with the surface. Examples of multi-touch devices include mobile devices (e.g., iPhone™, Nexus S™, Droid™ devices, etc.), tablet computers (e.g., iPad™, HP Touchpad™), portable/handheld game/music/video player/console devices (e.g., iPod Touch™, MP3 players, Nintendo 3DS™, PlayStation Portable™, etc.), touch tables, and walls (e.g., where an image is projected through acrylic and/or glass, and the image is then backlit with LEDs).

Some or all of the operations performed by the computer 102 according to the computer program 110 instructions may be implemented in a special purpose processor 104B. In this embodiment, the some or all of the computer program 110 instructions may be implemented via firmware instructions stored in a read only memory (ROM), a programmable read only memory (PROM) or flash memory within the special purpose processor 104B or in memory 106. The special purpose processor 104B may also be hardwired through circuit design to perform some or all of the operations to implement the present invention. Further, the special purpose processor 104B may be a hybrid processor, which includes dedicated circuitry for performing a subset of functions, and other circuits for performing more general functions such as responding to computer program instructions. In one embodiment, the special purpose processor is an application specific integrated circuit (ASIC).

The computer 102 may also implement a compiler 112 which allows an application program 110 written in a programming language such as COBOL, Pascal, C++, FORTRAN, or other language to be translated into processor 104 readable code. Alternatively, the compiler 112 may be an interpreter that executes instructions/source code directly, translates source code into an intermediate representation that is executed, or that executes stored precompiled code. Such source code may be written in a variety of programming languages such as Java™, Perl™, Basic™, etc. After completion, the application or computer program 110 accesses and manipulates data accepted from I/O devices and stored in the memory 106 of the computer 102 using the relationships and logic that was generated using the compiler 112.

The computer 102 also optionally comprises an external communication device such as a modem, satellite link, Ethernet card, or other device for accepting input from and providing output to other computers 102.

In one embodiment, instructions implementing the operating system 108, the computer program 110, and the compiler 112 are tangibly embodied in a non-transient computer-readable medium, e.g., data storage device 120, which could include one or more fixed or removable data storage devices, such as a zip drive, floppy disc drive 124, hard drive, CD-ROM drive, tape drive, etc. Further, the operating system 108 and the computer program 110 are comprised of computer program instructions which, when accessed, read and executed by the computer 102, causes the computer 102 to perform the steps necessary to implement and/or use the present invention or to load the program of instructions into a memory, thus creating a special purpose data structure causing the computer to operate as a specially programmed computer executing the method steps described herein. Computer program 110 and/or operating instructions may also be tangibly embodied in memory 106 and/or data communications devices 130, thereby making a computer program product or article of manufacture according to the invention. As such, the terms “article of manufacture,” “program storage device” and “computer program product” as used herein are intended to encompass a computer program accessible from any computer readable device or media.

Of course, those skilled in the art will recognize that any combination of the above components, or any number of different components, peripherals, and other devices, may be used with the computer 102.

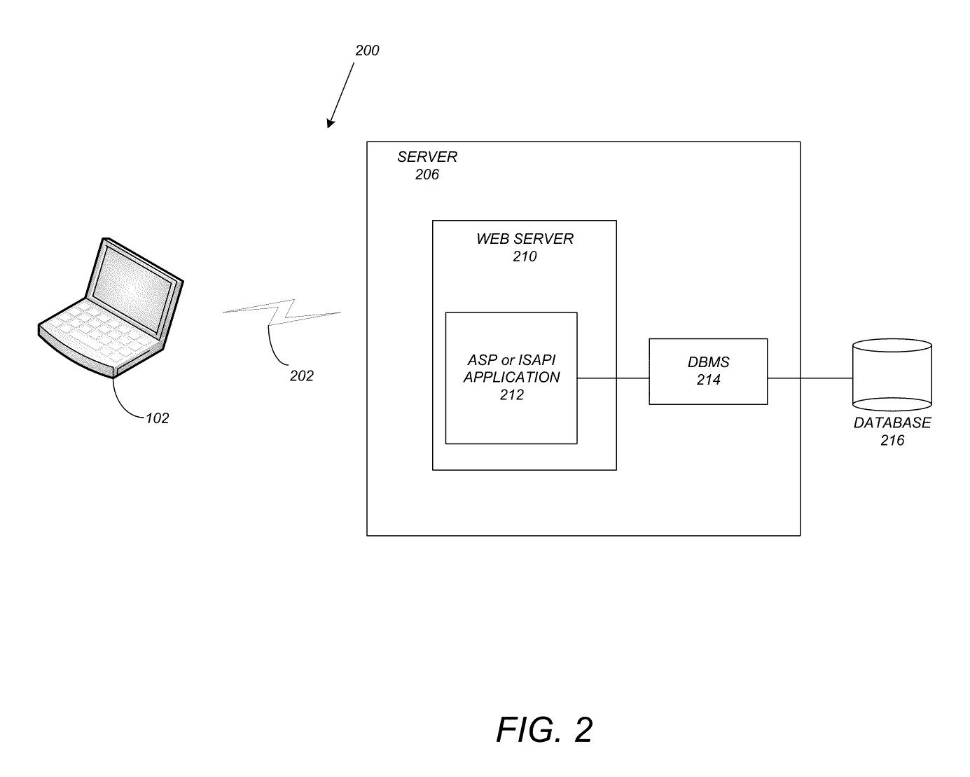

FIG. 2 schematically illustrates a typical distributed computer system 200 using a network 202 to connect client computers 102 to server computers 206. A typical combination of resources may include a network 202 comprising the Internet, LANs (local area networks), WANs (wide area networks), SNA (systems network architecture) networks, or the like, clients 102 that are personal computers or workstations, and servers 206 that are personal computers, workstations, minicomputers, or mainframes (as set forth in FIG. 1). However, it may be noted that different networks such as a cellular network (e.g., GSM [global system for mobile communications] or otherwise), a satellite based network, or any other type of network may be used to connect clients 102 and servers 206 in accordance with embodiments of the invention.

A network 202 such as the Internet connects clients 102 to server computers 206. Network 202 may utilize ethernet, coaxial cable, wireless communications, radio frequency (RF), etc. to connect and provide the communication between clients 102 and servers 206. Clients 102 may execute a client application or web browser and communicate with server computers 206 executing web servers 210. Such a web browser is typically a program such as MICROSOFT INTERNET EXPLORER™, MOZILLA FIREFOX™, OPERA™, APPLE SAFARI™, GOOGLE CHROME™, etc. Further, the software executing on clients 102 may be downloaded from server computer 206 to client computers 102 and installed as a plug-in or ACTIVEX™ control of a web browser. Accordingly, clients 102 may utilize ACTIVEX™ components/component object model (COM) or distributed COM (DCOM) components to provide a user interface on a display of client 102. The web server 210 is typically a program such as MICROSOFT'S INTERNET INFORMATION SERVER™.

Web server 210 may host an Active Server Page (ASP) or Internet Server Application Programming Interface (ISAPI) application 212, which may be executing scripts. The scripts invoke objects that execute business logic (referred to as business objects). The business objects then manipulate data in database 216 through a database management system (DBMS) 214. Alternatively, database 216 may be part of, or connected directly to, client 102 instead of communicating/obtaining the information from database 216 across network 202. When a developer encapsulates the business functionality into objects, the system may be referred to as a component object model (COM) system. Accordingly, the scripts executing on web server 210 (and/or application 212) invoke COM objects that implement the business logic. Further, server 206 may utilize MICROSOFT'S™ Transaction Server (MTS) to access required data stored in database 216 via an interface such as ADO (Active Data Objects), OLE DB (Object Linking and Embedding DataBase), or ODBC (Open DataBase Connectivity).

Generally, these components 200-216 all comprise logic and/or data that is embodied in/or retrievable from device, medium, signal, or carrier, e.g., a data storage device, a data communications device, a remote computer or device coupled to the computer via a network or via another data communications device, etc. Moreover, this logic and/or data, when read, executed, and/or interpreted, results in the steps necessary to implement and/or use the present invention being performed.

Although the term “user computer”, “client computer”, and/or “server computer” is referred to herein, it is understood that such computers 102 and 206 may include thin client devices with limited or full processing capabilities, portable devices such as cell phones, notebook computers, pocket computers, multi-touch devices, and/or any other devices with suitable processing, communication, and input/output capability.

Of course, those skilled in the art will recognize that any combination of the above components, or any number of different components, peripherals, and other devices, may be used with computers 102 and 206.

### Event Site Overview

Embodiments of the invention are implemented as a software application executing on a client 102, server computer 206, or a combination of both client 102 and server 206. Further, as described above, the client 102 or server computer 206 may comprise a thin client device or a portable device that has a multi-touch-based display (i.e., a tablet device), a mobile phone, a gaming system, an IP (internet protocol) enabled television, a television set top box, or other internet enabled device running on various platforms and operating systems. Users may communicate and interact with the software application using a mobile device, client computer 102, portable device, etc.

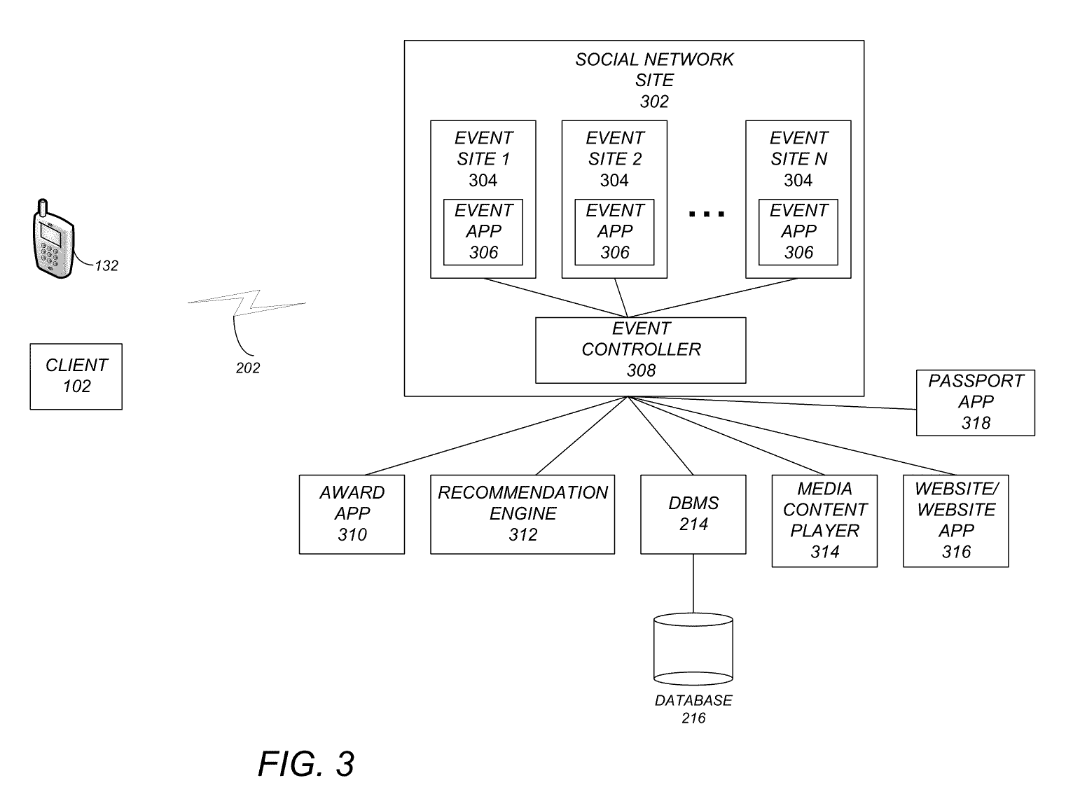

FIG. 3 illustrates the general structure and interaction within an event based framework/system in accordance with one or more embodiments of the invention. As described above, mobile device 132 and/or client 102 may communicate and interact using a variety of networks 202 with various websites and applications. Mobile application software (commonly referred to as an “app”) may be installed and/or utilized on mobile devices 132 and/or clients 102. Such an app may be downloaded from an application marketplace or online store of applications. The app may be used to provide the functionality herein. In addition, various apps may be used in combination with server side applications to provide the desired functionality. In this regard, in addition to, or instead of, an event app on a mobile/client device 102/132, an application for the user to check-in or submit his/her location may be used (e.g., FourSquare™).

On the server side 206, a social network site 302 (e.g., MySpace™, Facebook™, Linkedln™, Friendster™, Twitter™), may be used to host various event sites 304 (e.g., event site 1, event site 2, . . . , event site N). Such event sites are described in further detail below and correspond to actual events that are occurring at a particular venue. Each event site 304 may utilize an event application 306 to manage the information for the event site 304. Further, an event controller 308 may be used to combine, manage, and provide access to information from multiple event sites 304/event applications 306.

Either as part of the social network site 302 or executing separately from the social network site 302, various applications 310-318 may be used to provide additional features for the event-based interaction. The use of such applications 310-318 are described in further detail below. It may be noted that the description is not limited to the applications depicted in FIG. 3 and additional applications may be used to provide the features described herein. Further, in addition to the applications 310-318 interacting with (or being an integral part of) social network site 302, each application 302-318 may interact with the other applications 302-318 and or directly with the user 102/132.

To better understand the event based framework and system, an overview of each of the depicted applications' tasks within the event based framework may be useful. Award application 310 manages awards, award programs, and achievements based on a user's 102/132 level/state of participation and interaction with the event based system. Recommendation engine 312 is used to recommend content, events, etc. to a user 102/132 based on event based content. DBMS 214 manages all of the event based data that may be stored in database 216. Media content player 314 enables the ability to view media content uploaded by users 102/132. Websites/website apps 316 are websites other than the social network site 302 (e.g., Twitter™, search engines, map-based interactions, etc.) that may use the event based information or provide additional information based on the event-based information. Such websites/website apps 316 also interact with the event app 306 and/or event controller 308. Passport app 318 enables the use of an event passport/passport book that serves as a listing or registry of which events one or more users 102/132 have attended.

As described herein, an event (e.g., a concert, a sporting event, a party, a charity event, a theatrical production, or any event that may be attended/watched by a user) may have a corresponding event internet presence (referred to herein as an event site or event location 304) that is hosted by a server computer 206. Such an event site 304 may be an application 212 hosted by web server 210, and/or may be a page on a social media network 302 such as a MySpace™ page, a Facebook™ page, a Google+™ page, a LinkedIn™ page, etc.

The event site 304 may utilize an event application 306 to organize and store the information on a per event site 304 basis. In general, the event site 304 (and supporting applications 306-318) provides the ability for users 102/132 to “check into” an event and upload content directly from the actual event using a mobile application. The server 206 (e.g., via the event app 306, event controller 308, and or other applications) may verify the user's location at the event (e.g., via global positioning system [GPS] information encoded in a picture or transmitted from the mobile device) (and may also confirm the content location) and tags the data appropriately. The event site 304 serves as an aggregate for the user content uploaded from the event. Any user 102/132 can visit the site and view the content. Alternatively, access permissions may be restricted (e.g., private event functions [e.g., birthday parties, exclusive parties at private estates, etc.] may have access restricted to only those persons that attended/were invited to the event).

In addition to manually “checking-in,” embodiments of the invention may provide an automated check-in recommendation function. By using GPS latitude/longitude location information combined with known start/end dates of events in proximity (e.g., geographic proximity as well as time based proximity), an automated prompt may suggest that the user 102/132 “check-in” to the likely event(s) he/she is uploading content from.

The uploaded content may be pictures, sound, video, information about the event or participants in the event, and information about the pictures, sound, video, or other content (e.g., attributes about the content), etc. The content described herein is not intended to be limited to specific content or types of content. For example, at a baseball game, content may include a picture of a message displayed on a big screen, a picture of any of the players (in the dugout or otherwise), who is at bat, what celebrities are attending the game, the total attendance, where a beach ball is currently being hit, where a “wave” is starting, how long the lines are at the different concessions or in the bathrooms, where to buy certain types of food, GPS data associated with any of the above, etc. Similarly, at a concert, content may include the current song being played, a picture of the band, a picture of an attendee, a picture of a ticket to the concert, what clothing a particular artist is wearing, etc.

The event site 304 may enable usage of the event site 304 before, during, and subsequent to the occurrence of the event. Before the event occurs, users 102/132 can view the scheduled participants (e.g., the scheduled pitchers or players at a baseball game, scheduled artists at a concert, etc.) and/or information about the event (e.g., songs played at other similar concerts, the scheduled playlist, information about the instruments being played and similar artists that play the same/similar instruments, information about the promoter, the master of ceremonies (MC), production crew, etc.). Users 102/132 may also have the potential to purchase tickets to the event or link to another site 316 to purchase tickets.

During the event itself, content is uploaded and may be streamed and/or used by users 102/132 (e.g., in real-time). Such content may be used to find concessions/bathrooms (e.g., with the shortest line), meet up with friends, view what is happening at a different location at the venue, etc.). Users 102/132 not at the event may also have the ability to view uploaded content to attend the event “virtually”.

After the event, users 102/132 can view and interact with the uploaded content (e.g., including the set played by an artist, pictures, video, etc.). Similarly, content uploaded may be utilized by other applications 310-318. As an example, a music player 314 may utilize the content such that when playing a song, relevant content (e.g., pictures of the artist playing that song at a particular concert) may be displayed to the user 102/132. Alternatively, a user 102/132 can “relive” the event wherein the content (and accompanying information) is organized in a timeline-like manner and delivered to the user 102/132 such that the user 102/132 can replay the content in an attempt to experience/re-experience the evening. For example, a user 102/132 can attempt to replay a concert event. In such a scenario, the application 306 may replay/stream music to the user 102/132 in the order that the band played the set at the concert event. Simultaneously, the application 306 may display pictures, audio, video, etc. that is synchronized with the music (e.g., the time when the content was captured by a user 102/132 may be synchronized with when a particular song was played by a band and delivered to the user 102/132 in a time appropriate manner).

In another example, sequenced images taken during a event (e.g., concert) can be photo-stitched together, and an animated photo-representation of the event may be created. Such a photo-representation may be done in conjunction with a photosynthesizing type of product that creates an immersive 2D/3D image such as a panorama (e.g., the Photosynth™ viewing application). Such a photo-representation may be similar to a flip-book concept but utilizes digital imagery uploaded from the audience of an event.

Accordingly, the application controller 308 (e.g., via the event app 306) may offer various options to one or more users 102/132 regarding how the content can be delivered to the user 102/132. The user 102/132 may also opt to simply browse all uploaded content. In yet another embodiment, a user 102/132 can elect to filter the content based on a variety of factors/attributes. Some filtering options may include filtering the content by: the user 102/132 that uploaded the content, the type of device that captured the content (e.g., cellular phone v. digital camera v. tablet/multi-touch device), the location at the actual event where the content was captured (e.g., filtering content such that only content captured by users 102/132 in the first ten rows or in a particular venue section will be viewed by the user 102/132), by properties of the user 102/132 that captured the content (e.g., gender, age, profile of user 102/132 compared to the present user 102/132, etc.), by age appropriateness (e.g., if the content is marked with containing risque content, it may be filtered out, or content may be filtered based on being appropriate for all ages, only over 13, only over 18, etc.), by what is depicted in the content (e.g., filtering out all content but for images of the band members or certain band members—i.e., such that candid photos of other attendees at the event are excluded—or vice versa), etc. In this regard, any type of filtering system may be in place and a variety of different properties and attributes may be used to filter the content.

To further provide the ability to organize and filter the content in a desirable manner, the uploaded content may be tagged. Such tagging associates the content with a variety of attributes. In this regard, content may be associated with a song, event, playlist, users 102/132 (having a particular songs on a playlist, that have attended a particular concert, that uploaded a song at a concert, etc.), musical type/genre, venue, time captured, what/who is depicted in the picture, location (e.g., general seating section, exact seat location, and/or GPS location), etc.

Such content may be tagged by the user 102/132. Alternatively, the content may be tagged automatically by the application 306 (or other applications 310-318 that are configured to discover the tags) based on various properties. For example, based on GPS data that accompanies a photograph, the application 306-318 may search for and/or compare the GPS data to known GPS data for a particular venue and may further determine where the content was captured within the venue (e.g., what seating area or the exact location). The timestamp associated with the content may then be used to determine what event occurred, what was occurring at that time in the event (i.e., based on other user 102/132 uploaded content), etc. All such information may be associated with the content (e.g., via tags).

Automatic or manual tagging may also be initiated based on an ongoing activity at the event. For example, a user 102/132 may check-in at an event. The application 306-318 (or a mobile application on the mobile device 132 itself) may then perform an analysis of the audio content received (e.g., streamed to the application) to determine/identify what the content is (e.g., audio recognition of a particular song at a concert). Such an identification of the content may also utilize the “check-in” information to assist in the discovery process (e.g., by filtering songs from an artist performing at the venue). The application 306 may then request confirmation of the determination/identification and then store such content at the event site 304 (e.g., in database 216 via DBMS 214). In this regard, the time when a particular song is played may be automatically determined and stored at the event site 304 by an event application 306. Alternatively, rather than identifying/recognizing content based on audio, a user 102/132 may opt to submit identifying information based on text entries (e.g., via a mobile device 132 keyboard/text message). For example, at a concert, the user 102/132 may enter the first letter (or first few letters) of a song at a particular concert and the event app (e.g., on the mobile dev ice 132) may match the letters with a listing of songs by the artist and thereby recognize the song, or alternatively, present a list of songs for the user 102/132 to select from (i.e., based on the letters entered by the user 102/132).

As part of tagging or as a separate aspect, application 306 may attempt to correlate/determine information relating to an event based on information received from users 102/132. For example, application 306 (and or event controller 308) may attempt to correlate the estimated real start time of the opening band and headline band, based on analyzing heatmaps of image upload density and their change over time, on a venue by venue basis. In other words, application 306 may not only determine the start time of a particular event but may determine the average start time for events at a particular venue. For example, application 306 may suggest that 8:00 PM concerts at the Staples Center™ actually start closer to 8:25 PM. Further, application 306 may attempt to determine/derive song setlists based on analysis of videos taken during a concert (e.g., in the absence of or in combination with additional input identifying a song from users 102/132). The combination of timestamps, band metadata, and video fingerprinting could easily identify songs included in user uploaded videos, thereby allowing a dynamic automated assembly of the setlist in progress.

Further, embodiments of the invention may derive the high and low points during an event based on various types of explicitly and implicit inputs (e.g., realtime song rating meter, volume of tweeting occurring during various time windows, volume of photo uploads, etc.). Such high and low points may be viewed and/or provided to authorized persons (e.g. the artists or venue operators) to determine how to structure future events and to determine which types of activities are preferred by attendees.

A tagging infrastructure may also be utilized. Such a tagging infrastructure serves to establish a relationships for (and between) the uploaded content. For example, certain songs may be associated with a particular concert, events may be associated with artists/athletes, music at a concert may be associated with users 102/132 that have such music on their own playlists, etc. Such relationships between data may be stored in a database 216 and managed by a relational DBMS 214.

In view of the above, embodiments of the invention provide the ability for users 102/132 to tag themselves in pictures and videos of an event (e.g., concert) or having attended the event (before, during, or after). Tickets may also be sold for an event and a user 102/132 that purchased the tickets may automatically be tagged as having attended the event. Thus, the above described tags and all other tags may be used to associate an event with specific people and related other content (e.g., artist, genre, songs, etc.) in social media and content sites.

Interaction with Additional Applications/Websites

As described above, an event has a corresponding event site 304 that is hosted by a server computer 206. Such an event site 304 may be an application 306 and/or may be a page on a social media network 302 such as a MySpace™ page, a Facebook™ page, a Google+™ page, a Linkedln™ page, etc.

In addition, uploaded content may be connected to other websites 316 such as by posting the stream (i.e., of uploaded content) to a user's social media network news feed, blog, or microblogging service (e.g., Twitter™). In turn, the posting to another website 316 may serve to drive content back to the event site 304.

Additional applications 310-318 (as well as apps on mobile device 132) may also be configured to interact with the event application 306/event site 304. For example, as described above, a media player 314 may be configured to utilize information about the user 102/132, concerts the user 102/132 has attended, concerts that users 102/132 with similar preferences have attended, etc. to recommend and deliver both new artists/songs and/or content while playing music that was played at the concert (e.g., via interaction with a recommendation engine 312).

To store and recommend particular artists, songs, venues, etc., a database 216 may be used to store any information that is collected. Thereafter, a request received for media content (from a user 102/132 (or from an application that is providing media content to a user 102/132)) may be utilized by an application (e.g., recommendation engine 312 via DBMS 214) to query the database 216. Such a query may be conducted by a recommendation engine 312 that utilizes various algorithms to determine the media content to deliver. Such a recommendation engine 312 may utilize a combination of and variety of attributes/aspects in order to determine and recommend particular media content. For example, user profiles may be established, and based on similar profiles, the media content viewed by one user 102/132 may be recommended to another user 102/132. The analysis may further determine media content to recommend based on various combinations of the time of day, day of the week, prior media content viewing history (that may also be based on the time of day and or other profile information), location of the user 102/132 (e.g., in a car, in a particular city, identified as a tourist, on business, commuting, at an office, etc.), friends of the user 102/132, gender, age, etc.

In addition, fuzzy logic may be used in an attempt to determine what to recommend based on the event site specific information. Alternatively, fuzzy logic may be utilized to recommend an event site to a user 102/132 based on the approximate users 102/132 attributes and the predicted behavior of the user 102/132.

Fuzzy logic is a superset of conventional (Boolean) logic that has been extended to handle the concept of partial truth—truth values between “completely true” and “completely false”. With fuzzy logic, continuous truth values are permitted such that system variables may take a continuous range of truth-value memberships in the interval [0,1], rather than strict binary (True or False) decisions and assignments. For example, if it is cloudy and overcast, the statement “it is raining” could have a True value of 0.8, and a False value of 0.25. Likewise, the statement “The current user 102/132 is a visitor” has the value 0.9 if highly likely, 0.1 if highly unlikely, and 0.5 if the answer is “may be”. In embodiments of the invention, fuzzy logic may be utilized to determine the approximate media content to recommend to the user 102/132. Fuzzy logic may also be used to determine the likely event that the user 102/132 is attending based on approximate values/attributes provided by the user 102/132.

In another example, the likelihood of a user 102/132 attending a particular event may be predicted using fuzzy logic. In such an example, the normal location of a user 102/132 (e.g., in a particular suburb or in Los Angeles) may be compared to the user's current location (e.g., downtown or Seattle). Other attributes such as prior attendance at an event (e.g., concerts featuring a particular artist), travel to see such an event, in combination with known facts such as the location of the particular artist's concert the following evening in the vicinity of the user 102/132, may be used to predict with a particularly probability that a user 102/132 will attend the event. Based on such a probability, a particular event site 302 may be recommended to the user 102/132. Thus, an application 306-318 or recommendation engine 312 may rely on fuzzy logic in an attempt to drive traffic to an event site and may interact with such an event site 304 and/or information gathered by the event site 304.

Game-Based User Interaction with Event Site

To encourage users 102/132 to update and transmit content to an event site 304, embodiments of the invention may utilize a game-based user interaction. An award application 310 may be used to facilitate such an interaction. For example, via the award application 310, awards/rewards or some other form of encouragement may be provided to users 102/132 in exchange for updating and transmitting content to the event site 304.

Points/awards may be provided to the first user 102/132 that uploads certain content (such as a song currently playing at a concert), for updating content generally (e.g., uploading pictures), for “checking-in” at an event (e.g., registering the attendee's location at the event venue [e.g., via FourSquare™]), etc. Additional awards/points maybe awarded based on user 102/132 reaction to the content. For example, if users 102/132 like your pictures, or your content is getting more “hits” than other content, additional points/awards may be provided.

Awards may be directly related to the event or alternatively, points may be awarded and the user 102/132 may elect how/when to utilize the points collected. In this regard, points may be used to purchase/redeem a variety of different prizes/awards. Such an award may be similar to a mileage reward program. However, the difference lies in how the points are accrued. Further, in embodiments of the invention, the awards themselves may have a nexus with the event or participants/attendees of the event.

Examples of the awards may include special privileges for the user 102/132 (that may vary depending on the event). For example, if the event is a concert, special privileges may include early access to new artist tracks, artist chat participation, back stage passes to a future concert, VIP access to areas at the concert/future concert, upgraded seats, etc. Similarly, if the event is a sporting event, concert, or other event, special privileges may be access to an autograph session with one or more artists/athletes, free upgraded seats (if available), meet and greet with athletes/artists, tour of locker room, stadium, or VIP club access, meeting with broadcast announcers or tour of announcing booth, display of name on scoreboard (e.g., Jumbotron™), etc.

The point/award based system may also enable the event application 306 (via input from award application 310) to recognize the “top fan” of a particular event/artist/venue. In this regard, if a particular user 102/132 attends 40 ColdPlay™ concerts within a certain time frame, he/she may be considered ColdPlay™'s “top fan” and may be extended privileges based on such a status (e.g., free participation in the “fan club” or other artist specific rewards). Similarly, the top group of fans may be extended the same or different privileges.

Accordingly, the event site 304 and the event application 306 that gathers information from the event site can be used to drive users 102/132 to particular artists/events/venues in the future (e.g., via the award application 310). Such capabilities serve to increase publicity for an artist/event/venue. The awards may also be used to drive a user 102/132 to a different artist/event/venue. For example, if a user 102/132 has achieved numerous points for attending multiple concerts in a particular genre (e.g., punk rock), the awards to the person may provide free access/tickets to a different but similar artist (in the same genre). Awards may also be indirectly related to the artist/event/venue such as providing a coupon to a coffee shop or gas station adjacent to the venue. In yet another embodiment, the award may not be related to the artist/event/venue at all (e.g., a coupon to a supermarket).

In one or more embodiments, awards may be provided for the most active event content contribution and consumption/interaction. For example, the person 102/132 uploading the most pictures from a concert may be calculated in real time and rewarded by sending coupon barcodes (or QR [quick response] codes) back to the uploading device. This bar/QR code could in turn be used for credits at concessions, band merchandise, or even back stage entry. The use cases of such event currency can be determined by an event coordinator/administrator.

In view of the above, embodiments of the invention provide a game based user interaction with the event site 304 (via an awards application 310) that encourages the uploading of content and drives users 102/132 to the event site 304 based on redeeming/exchanging/awarding the uploading of content and certain types of content.

### Event Passport

Users 102/132 may have a passport/passport book (enabled via passport application 318) that contains/includes/is updated with the various events that the user 102/132 has attended. A user 102/132 can “check into” an event and have the event added to his/her passport book and later “relive” the event with the user 102/132 uploaded content. In this regard, the user 102/132 can stream the content that he/she has personally uploaded, or view all content uploaded (by all or a selected/filtered subset of users 102/132) to the event site 304.

In addition, awards (e.g., the awards described above with respect to the game based user interaction) may be provided for achieving certain milestones in the passport book (e.g., number of events attended, content uploaded by the user 102/132 at a certain number of events, etc.).

Such a passport/passport book may become a sort of social currency that can be compared and contrasted with other users' passports/passport books.

### Logical Flow

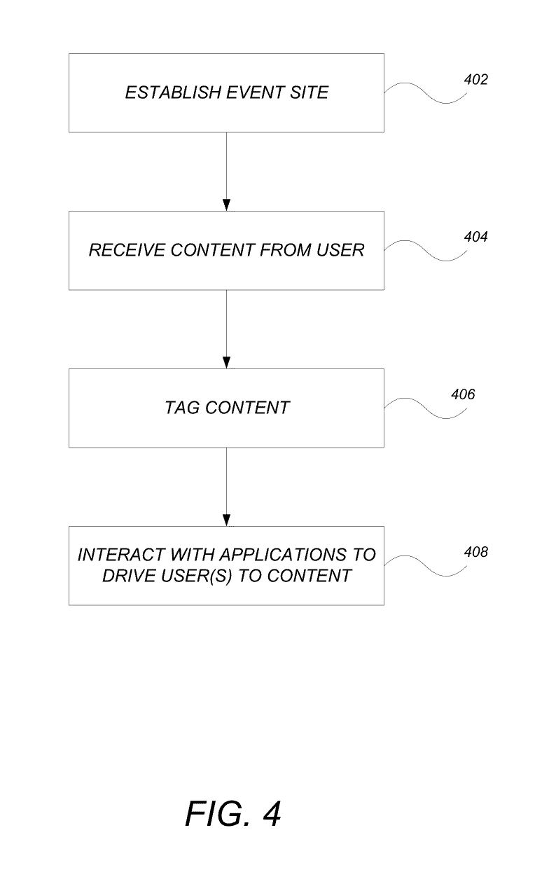

FIG. 4 illustrates the logical flow for providing an event application 306 in accordance with one or more embodiments of the invention.

At step 402, an event site is established. Such an event site may be hosted by a social media site and may include installing or utilizing a new instance (e.g., an object oriented instance) of an event application on the event site. To establish the event site, any known information may be stored/associated with the event. For example, the type of event, the artists/participants of the event, the venue, the location of the venue (e.g., latitude and longitude, GPS, street address, etc.) the time and date of the event, links to websites for any of the above, etc. The establishing/publishing/associating of such information with a particular event may all be automated. For example, an event application/controller may webcrawl and when a new upcoming event is discovered (e.g., at an artist's/team's web page, a ticketing company's webpage, etc.), information about the artist/team/venue may be automatically retrieved from a trusted source. The automatic gathering of such information may further provide the ability for an authorized user to confirm the information before, during, or after the establishment of the event site. Alternatively, an authorized user may be required to establish the event site and content initially stored thereon.

At step 404, content is received, at the event site, from one or more users. The event application may confirm the authenticity of the received content (e.g., via GPS data, receipt of tracking information (e.g., input of user information). The event application may also filter the content to determine if any impermissible content has been uploaded (e.g., obscene, illegal, or nefarious content, content that requires a license, content for which a minimum viewing age may be required, etc.).

At step 406, the content may be tagged as belonging to one or more classes of content. As described above, the tagging may associate the content with the event, venue, location, or any other attribute that could potentially be useful. The tagging information may be received by event site with the content itself (e.g., the user may indicate the content of the image). In this regard, the event app on the user's mobile device may have a series of tags that can be expanded, if desired, allowing the user to tag the content with a variety of different attributes prior to uploading to the event site. Alternatively, facial recognition software, audio recognition software, or other software may be used on the server-side to determine and tag the content appropriately.

At step 408, the event site interacts with applications to drive user(s) to the uploaded content and/or other content. As described above, such applications may include a media content player, a recommendation engine, an award application, a passport/passport book application, other websites/website applications, etc.

### CONCLUSION

This concludes the description of the preferred embodiment of the invention. The following describes some alternative embodiments for accomplishing the present invention. For example, any type of computer, such as a mainframe, minicomputer, or personal computer, or computer configuration, such as a timesharing mainframe, local area network, or standalone personal computer, could be used with the present invention.

The foregoing description of the preferred embodiment of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto.

What is claimed is:

1. A system for managing event-based information, comprising:
(a) a client application executing on a client device, wherein the client application:
uploads information about an event from a user of the client application to an event application;
(b) an event application executing on a server device, wherein the event application:
(1) manages the information for an event site, wherein the event site:
(i) corresponds to the event that multiple persons attend; and
(ii) is an electronic representation of the event;
(2) receives the information from the client application; and
(3) manages client access to the uploaded information.

2. The system of claim 1, wherein the client device comprises a mobile device.

3. The system of claim 2, wherein:
the event is taking place at a geographical location;
the event application utilizes a mobile geographical location of the mobile device to associate information uploaded from the client application with the event based on a similarity between the geographical location of the event and the mobile geographical location.

4. The system of claim 1, wherein:
a time when the information is captured by the user is utilized to identify and associate the information with the event.

5. The system of claim 1, wherein the event application is hosted on a social media network site.

6. The system of claim 5, further comprising:
a website other than the social media network site that interacts with the social media network site, wherein:
the website provides additional information to users that is based on the information.

7. The system of claim 1, further comprising an event controller that manages and provides access to the information from multiple event sites.

8. The system of claim 1, wherein:
the event application manages client access via an award application; and
the award application manages awards, award programs, and achievements based on a level of interaction of the user with the client application.

9. The system of claim 1, wherein:
the event application manages client access via a recommendation engine; and
the recommendation engine recommends content and events to the user based on the information.

10. The system of claim 1, wherein:
the event application manages client access via a media content player; and
the media content player displays information uploaded from the client application.

11. The system of claim 1, wherein:
the event application manages client access via an event passport application; and
the event passport application manages an event passport that serves as a registry of which events the user has attended.

12. The system of claim 1, wherein:
the event application tags the information uploaded from the client application; and
the tag associates the information with the event.

13. A method for managing event-based information, comprising:
establishing an event site wherein:
the event site corresponds to an event that multiple persons attend; and
is an electronic representation of the event;
receiving content, from a user, at the event site;
associating the content with one or more classes of content including the event site; and
interacting with an application to drive users to the content.

14. The method of claim 13, wherein the content is received from a user via a mobile device.

15. The method of claim 14, wherein:
the event is taking place at a geographical location;
the event application utilizes a mobile geographical location of the mobile device to associate the content with the event based on a similarity between the geographical location of the event and the mobile geographical location.

16. The method of claim 13, wherein:
a time when the content is captured by the user is utilized to identify and associate the content with the event.

17. The method of claim 13, wherein:
the application comprises an award application; and
the award application manages awards, award programs, and achievements based on a level of interaction of the user with the event site.

18. The method of claim 13, wherein:
the application comprises a recommendation engine; and
the recommendation engine recommends content and events to the user based on the content.

19. The method of claim 13, wherein:
the application comprises a media content player; and
the media content player displays the content uploaded from the client application.

20. The method of claim 13, wherein:
the application comprises an event passport application; and
the event passport application manages an event passport that serves as a registry of which events the user has attended.
